(19) United States
(12) Patent Application Publication
(10) Pub. No.: US 2005/0140131 A1
(43) Pub. Date: Jun. 30, 2005

(54) Motor vehicle frame rail strengthening system

(76) Inventor: D. William Smith, Lincoln, NE (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/022,459

(22) Filed: Dec. 22, 2004

Related U.S. Application Data
(60) Provisional application No. 60/533,630, filed on Dec. 31, 2003.

(51) Int. Cl. B62D 21/16

(52) U.S. Cl. 280/781

(57) ABSTRACT

In one configuration, the present system includes a top rail, a bottom rail, and a side rail that form an open-box automobile frame rail. At least one truss portion forms a diagonal between the top and bottom rails.

This application claims the benefit of U.S. Provisional Patent Application No. 60/533,630, filed Dec. 31, 2003 (Attorney Docket No. 7440-23), which is incorporated herein by reference.

### FIELD OF THE INVENTION

This invention relates generally to methods and apparatus for a strengthening system for use with a vehicle. More specifically, the present invention relates to the use of truss portions positioned to extend between and contact a top rail and a bottom rail of a frame rail to form a diagonal.

### BACKGROUND OF THE INVENTION

Traditionally, frame rails are used to support vehicles, and in particular frames of vehicles. These types of vehicles can include automobiles, light trucks, heavy trucks, custom cars, custom trucks, and one-off or proto-type motor vehicles. These frame rails typically have a sideways “U” shaped profile with a top portion, a side portion, a bottom portion and an open opposing side. Additionally, these frame rails are often part of a framing system used to support a particular automobile and various parts, such as an engine.

When a user desires to assemble or repair a vehicle it is often desirable that the automobile frame and other parts of the automobile, such as the engine, are level or horizontal to the automobile frame. Rotation, buckling, or other distortion of the frame rails can affect the position and orientation of the engine and the automobile frame relative to each other and relative to the ground surface. The orthogonality of the fully assembled vehicle may be affected by movement of the frame rails during assembly or use of the vehicle.

An improved strengthening system is desired.

### SUMMARY OF THE INVENTION

In one basic configuration, the present system forms a strengthening system for use with an automobile frame. The present system includes a top rail, a bottom rail, and a side rail. The top rail, bottom rail, and side rail are connected together to form an automobile frame rail having an open, box shaped cross-section. At least one truss portion is positioned to form a diagonal between the top rail and the bottom rail and preferably a plurality of truss portions extend between and contact the top rail and the bottom rail. In one preferred embodiment, the top rail, the bottom rail, and the side rail are integrally cast. In certain preferred embodiments, the truss portions are configured to contact the side rail and may be connected in place, for example by welding. In certain preferred embodiments, a second side rail is attached to the frame rail to form a closed tube having a substantially rectangular cross-section.

In an alternate embodiment, the present invention includes a method of strengthening a pair of frame rails to support an automobile. A pair of top rails, a pair of bottom rails, a pair of side rails, and a plurality of truss portions are provided. Each of the top rails is configured to receive a portion of the automobile and each of the bottom rails is configured to align with the pair of top rails. A pair of open frame rails is formed from the pair of top rails, the pair of bottom rails, and the pair of side rails. The plurality of truss portions are positioned in the pair of open frame rails to form a plurality of diagonals that extend between and contact the top rails and the bottom rails. In certain preferred embodiments, a frame assembly is formed from the pair of open frame rails and at least one crossbeam. In one preferred embodiment, a second pair of side rails is attached to the pair of open frame rails to form a pair of closed frame rails.

It is an object of the invention to provide a strengthening system.

Further objects, features and advantages of the present invention shall become apparent from the detailed drawings and descriptions provided herein.

### BRIEF DESCRIPTION OF THE DRAWINGS

FIG. 1 is a perspective top view of a strengthening system according to a preferred embodiment of the present invention.

FIG. 2 is a perspective side view of a strengthening system according to a preferred embodiment of the present invention.

FIG. 3 is a perspective top view of a frame according to a preferred embodiment of the present invention.

### BRIEF DESCRIPTION OF PREFERRED EMBODIMENTS

While the present invention may be embodied in many different forms, for the purpose of promoting an understanding of the principles of the invention, references will now be made to the embodiments illustrated in the drawings and specific language will be used to describe the same. It will nevertheless be understood that no limitation of the scope of the invention is thereby intended. Any alternations and further modifications in the described embodiments, and any further applications of the principles of the inventions as described herein are contemplated as would normally occur to one skilled in the art to which the invention relates.

Certain preferred embodiments of the present system include a top rail, a bottom rail, and a side rail. The top rail, bottom rail, and the side rail are connected to form a frame rail with an open sideways “U” shaped or a “C” shaped cross-section. The present system also includes at least one and preferably a plurality of truss portions to strengthen the frame rail between the top and bottom rails. Each of the truss portions extends between and contacts the top rail and bottom rail. For example, each truss portion is positioned to form a diagonal between the top and bottom rails. The truss portions form a first plurality of contact points along the top rail and a second plurality of contact points along the bottom rail. In certain preferred embodiments, each truss portion is a single plate. Optionally, the plurality of truss portions may be formed from one unitary plate that is bent at multiple locations to form a zigzag plate. A second side rail is optionally attached to the frame rail to form a closed tube with a substantially rectangular cross-section.

Optionally, the top rail, the bottom rail, the side rail, and the at least one truss portion are formed from steel. In one preferred embodiment, the top rail, the bottom rail, and the side rail are integrally cast. In certain preferred embodiments, a plurality of truss portions form a first plurality of contact points along the top rail and a second plurality of contact points along the bottom rail such that the first distance between a pair of first contact points and the second distance between a pair of second contact points are substantially equal to each other. In an example, the first distance and the second distance are each approximately 7 inches. In one preferred embodiment, each of the truss portions contacts the side rail.

In another preferred embodiment, the present system includes a method of strengthening a pair of frame rails to support an automobile. A pair of open frame rails is assembled from a pair of top rails, a pair of bottom rails, and a pair of side rails. Each of the top rails is configured to receive portions of the automobile. Each of the bottom rails is configured to align with the top rails. Optionally, for the bottom rails to align with the top rails, the bottom rails may have a length substantially equal to a length of the top rails. In another option, the length of the bottom rails may differ from the length of the top rails. In yet another option wherein the bottom rails align with the top rails, the bottom rails may be parallel to the top rails. In certain preferred embodiments, the bottom rails are not parallel to the top rails, for example the top and bottom rails may vary in their spacing. The height of the side rails may vary such that the side rail edges continuously contact the top and bottom rail edges respectively. Each of a plurality of truss portions is positioned in the pair of frame rails to form a plurality of diagonals that extend between, contact and strengthen the top rails and the bottom rails.

A frame is formed from the pair of frame rails and at least one cross-beam in certain preferred embodiments. Optionally, the plurality of truss portions is welded to the top rails and the bottom rails. In one option, a second pair of side rails is attached to the frame rails to form a pair of closed frame rails.

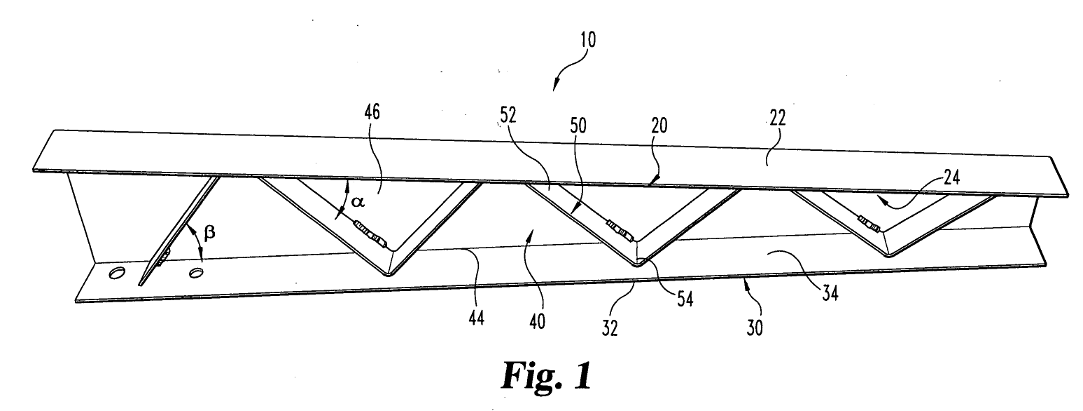

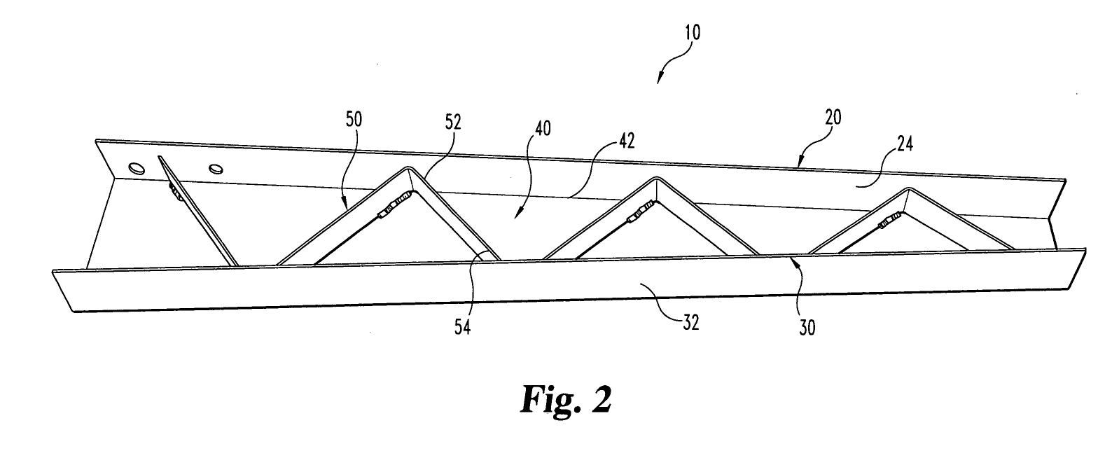

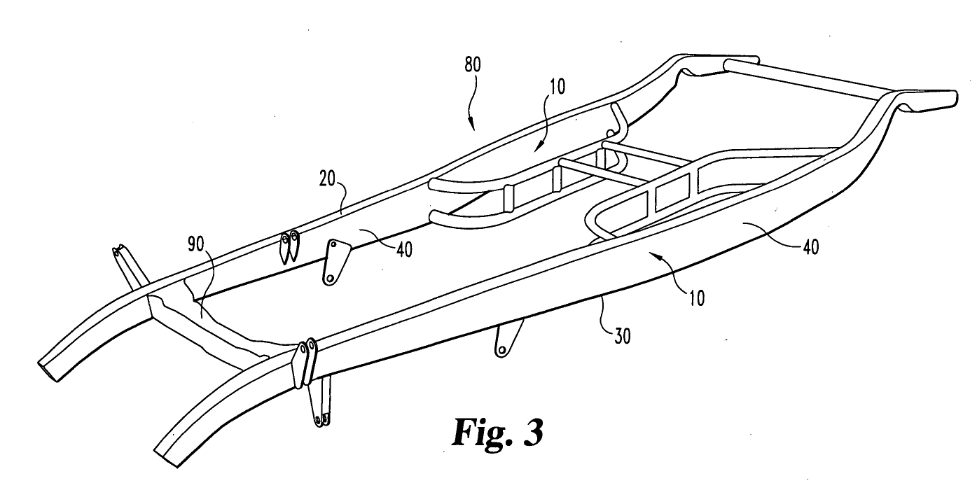

A perspective view of a frame rail portion according to one preferred embodiment of the present invention is illustrated in FIG. 1. The frame rail 10 includes top rail 20, bottom rail 30, side rail 40, and a plurality of truss portions 50. As illustrated in FIG. 1, top rail 20 is a flat plate with a generally rectangular shape. Alternately, top rail 20 may have flat portions and curved portions along its length as shown in FIG. 3. In another form, top rail 20 may be shaped differently, such as a tube or a bracket, to name a few shapes. Preferably, top rail 20 is shaped to align with and/or support portions of an automobile. Top rail 20 has an automobile engaging surface 22 and an interior truss portion engaging surface 24 as shown in FIGS. 1 and 2.

As shown in FIGS. 1 and 2, bottom rail 30 is a flat plate with a generally rectangular shape. Alternately, bottom rail 30 may have flat portions and curved portions along its length as shown in FIG. 3. In other forms, bottom rail 30 may be shaped differently, such as a tube or a bracket. The bottom rail 30 is shaped to match at a spaced distance from top rail 20, as discussed below. Bottom rail 30 has a bottom surface 32 and an interior truss portion engaging surface 34.

Side rail 40, as illustrated in FIG. 1, is shown as a flat plate with a generally rectangular shape. Optionally, side rail 40 may be shaped differently, such as a tube or a bracket, to name a few shapes. Side rail 40 includes a top rail engaging edge 42, a bottom rail engaging edge 44, and an inside portion 46. In certain preferred embodiments, the height of side rail 40 may vary along its length. Top rail engaging edge 42 is preferably arrangeable to contact truss portion engaging surface 24 of top rail 20. In this embodiment, top rail engaging edge 42 mates with the edge of truss portion engaging surface 24. Bottom rail engaging edge 44 is preferably arrangeable to contact the edge of truss portion engaging surface 34 of bottom rail 30. Further, the bottom rail engaging edge 44 mates with the edge of truss portion engaging surface 34.

In one form, top rail 20, bottom rail 30, and side rail 40 align to form a sideways “U” shaped profile or a “C” shaped profile as shown in FIG. 1. The side rail 40 may be mounted to the outer edges of the top rail 20, and the bottom rail 30, or the side rail 40 may be inset slightly along the side between the top rail 20 and the bottom rail 30. The “C” shaped profile of the top rail 20, bottom rail 30, and side rail 40 may vary in height between top rail 20 and bottom rail 30 along the length of top rail 20 and bottom rail 30. In another option, the “C” shaped profile of the top rail 20, bottom rail 30, and side rail 40 has a substantially constant height. Preferably top rail 20, bottom rail 30, and side rail 40 are integrally cast. In another form, top rail 20, bottom rail 30, and side rail 40 are attached, for example by welding, bolting, riveting, fusing, and/or bonding using composite materials. Various materials may be used to form top rail 20, bottom rail 30, and side rail 40, such as stainless steel, steel, other metals, or composites, to name a few.

In certain preferred embodiments, a second side rail 40 may be used to close the fourth side of the “C” shaped member to enclose frame rail 10, as shown in FIG. 3. The second side rail 40 may be mounted to the outer edges of the “C” shaped member, or may be inset slightly along the side between the top rail 20 and the bottom rail 30. In one preferred embodiment, the second side rail 40 forms a closed frame rail. In another preferred embodiment, the second side rail 40 forms a rectangularly shaped tube from the “C” shaped member. The second side rail 40 may be attached to the fourth side of the “C” shaped member, for example by welding, bolting, riveting, fusing, and/or bonding using composite materials.

A plurality of truss portions 50 is illustrated in FIG. 1. Each of the plurality of truss portions 50 includes a top rail engaging end 52 and a bottom rail engaging end 54. As will be understood, the perspective on truss portions 50 is reversible, therefore “top” and “bottom” labels are for illustration only.

Preferably, each of the plurality of truss portions 50 is a flat plate with a generally rectangular shape. Alternate geometric shapes can be used as desired for the plurality of truss portions 50 such as, a cylinder, a tube, or a channel to name a few. Preferably, truss portions 50 strengthen frame rails and function to prevent warping, buckling, and/or bending of the top rail 20 with respect to bottom rail 30.

Each truss portion 50 has a width, which partially determines its strength. Optionally, each of the plurality of truss portions 50 has a width extending substantially across the interior of the “C” shaped member to contact the inside portion 46 of the side rail 40. In the embodiments where a second side rail 40 is used to enclose frame rail 10, each of the truss portions 50 can extend across the interior of the frame rail to contact the inside portions 46 of both side rails 40.

Each of truss portions 50 extends the height of the “C” shaped profile along a diagonal between the top rail 20 and the bottom rail 30 as shown in FIGS. 1 and 2. In certain preferred embodiments, the plurality of truss portions 50 is formed from one unitary plate that is bent at multiple locations to form a zigzag shape of desired angles and distances between the bent portions of the plate. In one embodiment, various truss portions 50 have various lengths for corresponding locations. In another embodiment, each of the truss portions 50 has the same length. The top rail engaging end 52 of each of the truss portions 50 contacts the truss portion engaging surface 24 to form a first plurality of contact points along the top rail 20 and a first plurality of angles, α, measured between the truss portion engaging surface 24 and each of the truss portions 50. The bottom rail engaging end 54 of each of the truss portions 50 contacts the truss portion engaging surface 34 to form a second plurality of contact points along the bottom rail 30 and a second plurality of angles, β, measured between the truss portion engaging surface 34 and each of the truss portions 50.

Preferably, a first distance measured between a pair of the first plurality of contact points and a second distance measured between a pair of the second plurality of contact points are substantially equal to each other. In one embodiment, the first distance and the second distance are each approximately 7 inches. In another embodiment, the first distance and the second distance are each approximately 8 inches.

In one preferred embodiment, the truss portions 50 are placed along a portion of the frame rail. Optionally, the truss portions 50 can be placed over the entire length of the top rail 20, bottom rail 30, and side rail 40. The truss portions 50 may be optionally secured to side rail 40, by welding, fusing, riveting, bolting, and/or bonding using composite materials, to name a few forms of attachment.

In one preferred method, an open frame rail 10 is formed from the top rail 20, the bottom rail 30, and the side rail 40 as described above. During assembly of the frame rail 10, the plurality of truss portions 50 are positioned in the open frame rail to form a plurality of diagonals that extend between and contact the top rail 20 and the bottom rail 30. The plurality of truss portions 50 are positioned in the open frame rail to enhance the strength of the open frame rail. For example, the angles α and/or β can vary for optimal strengthening of the frame rail. As another example, the width and/or length of the plurality of truss portions 50 can be selected to increase the strength of the open frame rail. The plurality of truss portions 50 may be placed to contact and attached to the side rail 40 as described above.

In one embodiment, shown in FIG. 3, a frame 80 is shown. Frame 80 includes a pair of frame rails 10 and at least one crossbeam 90. Crossbeam 90 is a tube with a generally rectangular or circular cross-sectional shape. Alternately, crossbeam 90 may be another cross-sectional shape such as square or elliptical. In another option, crossbeam 90 may be a solid tube or plate. Preferably, crossbeam 90 may be secured to the pair of frame rails 10 by welding, fusing, bolting, riveting, and/or bonding using composite materials, to name a few forms of attaching the crossbeam 90. In one option, a plurality of beams 90 may be secured to the pair of frame rails 10. In this option, the plurality of beams 90 may be shaped similar to each other. In another option, the plurality of beams 90 may be shaped differently from each other.

As one example, the frame 80 may be sized for Ford automobiles, light trucks, heavy trucks, custom cars, and custom trucks between the years of 1909 and 1970. In particular, the frame 80 may be sized for a 1932 Ford automobile.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected.

1. A strengthening system for use with an automobile frame, comprising:
a. a top rail;
b. a bottom rail;
c. a side rail;
d. wherein said top rail, said bottom rail, and said side rail are connected to form an automobile frame rail having an open box shaped cross-section;
e. at least one truss portion within said cross-section wherein said at least one truss portion is positioned to form a diagonal which extends between and contacts said top rail and said bottom rail.

2. The strengthening system of claim 1, comprising a second side rail configured to attach to said frame rail to form a tube with a substantially rectangular cross-section.

3. The strengthening system of claim 1, comprising a plurality of truss portions to contact and form diagonals between said top rail and said bottom rail.

4. The strengthening system of claim 3, wherein said truss portions are substantially equally spaced.

5. The strengthening system of claim 4, wherein said equal spacing between said truss portions is approximately 7 inches.

6. The strengthening system of claim 4, wherein said equal spacing between said truss portions is approximately 8 inches.

7. The strengthening system of claim 1, wherein said top rail, said bottom rail, said side rail, and said at least one truss portion are formed from steel.

8. The strengthening system of claim 1, wherein said at least one truss portion contacts said side rail.

9. The strengthening system of claim 8, wherein said at least one truss portion is welded to said side rail.

10. The strengthening system of claim 1, wherein said top rail, said bottom rail, and said side rail are integrally cast.

11. The strengthening system of claim 1, wherein said at least one truss portion is formed from a plate bent in a zigzag shape.

12. The strengthening system of claim 1, comprising a plurality of truss portions, and wherein said truss portions are a plurality of plates having a variety of lengths.

13. The strengthening system of claim 12, wherein a first angle between said truss portion and said bottom rail and a second angle between said truss portion and said top rail are substantially equal to each other.

14. The strengthening system of claim 13, wherein said cross-section has a variable height.

15. A method of strengthening a pair of frame rails to support an automobile, comprising:
a. providing a pair of top rails, each of said top rails configured to receive a portion of an automobile;
b. providing a pair of bottom rails, each of said bottom rails configured to align with said pair of top rails;
c. providing a pair of side rails, each of said side rails configured to align with said pair of top rails and said pair of bottom rails;
d. providing a plurality of truss portions;
e. forming a pair of open automobile frame rails from said pair of top rails, said pair of bottom rails, and said pair of side rails; and
f. positioning said plurality of truss portions in said pair of open frame rails to form a plurality of diagonals that extend between and contact said top rails and said bottom rails.

16. The method of claim 15, wherein each of said pair of top rails includes a flat portion and a curved portion.

17. The method of claim 15, further comprising:
a. providing at least one crossbeam;
b. forming a frame from said pair of open frame rails and said at least one crossbeam.

18. The method of claim 15, further comprising welding said plurality of truss portions to said pair of side rails.

19. The method of claim 15, further comprising:
a. providing a second pair of side rails; and
b. attaching said second pair of side rails to said pair of open frame rails to form a pair of closed frame rails.

20. The method of claim 19, further comprising welding said second pair of side rails to said pair of open frame rails.
